(19) United States
(12) Patent Application Publication
(10) Pub. No.: US 2003/0160454 A1
(43) Pub. Date: Aug. 28, 2003

(54) Renewabel gravity, wind and solar energy engine

(76) Inventors: John Manolis, New York, NY (US); Pete Manolis, New York, NY (US)

Correspondence Address: John Manolis, Ph.D., P.O. Box 380, New York, NY, 10028, US

(21) Appl. No.: 10/081,959

(22) Filed: Feb. 25, 2002

(51) Int. Cl. H02P 9/04

(52) U.S. Cl. 290/1 R

(57) ABSTRACT

A new renewable gravity, wind and solar energy engine, comprising: an engine block which houses a crankshaft, flying wheels and mechanical transmissions, a fulcrum is mounted on top of said engine block, a straight lever is mounted on the fulcrum and has connecting pins on the ends across the fulcrum; the connecting pins are connected to connecting rods, said connecting rods are connected to said crankshaft. An electric motor vehicle with wheels and loaded with heavy masses moves on the straight lever forward and backward from one end to the other end of the straight lever over the fulcrum. The heavy masses generate force at the ends of the lever which forces the connecting rods to move downward and upward reciprocally to convert lever drive into rotary movement of the crankshaft.

### BACKGROUND OF THE INVENTION

The present invention relates to a new renewable energy engine, which uses gravity, solar and wind energy. This engine comprises an engine block which houses a crankshaft, flying wheels and mechanical transmissions. A fulcrum mounted on the top of the engine's block, a lever is mounted on the fulcrum, the lever may be of various configurations, such as, a straight lever or a circular lever. The fulcrum is mounted on the center of the straight lever and diametrically on the center of the circular lever. On the ends of the levers and across the fulcrum are mounted connecting pins, the connecting pins are connected to connecting rods, the connecting rods extend downward and are connected to the crankshaft. The straight lever has two straight rails mounted longitudinal on the top. The circular lever has two circular rails mounted on the top. A motor vehicle with wheels is powered by a hydrogen fuel cells engine and an electric motor. The vehicle is loaded with heavy masses. On the straight lever the vehicle with the heavy masses is running forward and backward on the rails. When the car moves forward past the fulcrum and goes toward the front end of the lever, the front end of the lever moves downward forcing the connecting rods to move downwards to convert lever drive into rotary movement of the crankshaft.

The circular lever has the fulcrum mounted diametrically in the center, two circular rails are mounted on top of the circular lever. Two connecting pins are mounted on the circular lever on each side of the fulcrum, the connecting pins are connected to connecting rods, which connecting rods are connected to a crankshaft, like in an internal combustion engine. The vehicle with heavy masses is running in a circle clockwise, when the car passes over the fulcrum one side of the circular lever tilts downward forcing the connecting rods to move downward to convert lever drive into rotary movement of the crankshaft like in an internal combustion engine.

### SUMMARY OF THE INVENTION

It is an object of the present invention to provide a renewable wind, solar and gravity energy engine.

It is another object of the present invention to provide a new renewable wind, solar and gravity energy engine, which comprises an engine block housing a crankshaft, flying wheels, mechanical transmissions and a fulcrum for the lever.

It is a further object of the present invention to provide a new renewable wind, solar and gravity energy engine, comprises a solar cell panel, a horizontal-axis wind turbine and a battery.

Still it is another object of the present invention to provide a new renewable solar, wind and gravity energy engine, which has a lever with a fulcrum and moving masses.

Still it is a further object of the present invention to provide a new renewable solar, wind and gravity energy engine, which comp rises levers, connecting rods and crankshafts.

Yet it is another object of the present invention to provide a new renewable wind, solar and gravity energy engine, in which connecting rods convert levers drive into rotary movement of crankshafts.

Yet it is a further object of the present invention to provide a new renewable wind, solar and gravity engine, which employs an electric motor and a hydrogen fuel cells engine to move the heavy masses forward and backward over the fulcrum of the lever.

### BRIEF DESCRIPTION OF THE DRAWINGS

FIG. 1 is a front and top view of a wind, solar and gravity engine showing the heavy masses past over the fulcrum and forcing downwards the lever and the connecting rod which connecting rod converts lever drive into rotary movement of a crankshaft.

FIG. 2 is the same as FIG. 1 showing the heavy masses to pass over the fulcrum to the other side forcing downwards the other end of the lever, which is forcing downwards the connecting rods which convert lever drive into rotary movement of a crankshaft.

FIG. 3 is a top and front view of a wind, solar and gravity engine with a circular lever, the heavy masses are rotating clockwise around the lever, when the heavy masses pass over the fulcrum, one side of the circular lever tilts downwards forcing the connecting rods to move downward to convert lever drive into rotary movement of the crankshaft.

FIG. 4 is the same as FIG. 3 showing the heavy masses, pass over the fulcrum from one side to the other side to convert lever drive into rotary movement of a crankshaft.

FIG. 5 is a top and front view of a wind, solar and gravity engine showing a hybrid leverage, a circular lever and a flat straight lever; both levers are mounted on the same fulcrum, the heavy masses on the straight lever move forward and backward. The heavy masses on the circular lever circulate clockwise on the circular level; both masses move downward, the connecting rods reciprocally to convert levers drive into rotary movement of a crankshaft.

FIG. 6 is the same as FIG. 5 showing the heavy masses pass over the fulcrum from one side of the fulcrum to the other side reciprocally, both masses force the connecting rods to move downward to convert levers drive into rotary movement of the crankshaft.

### DETAILED DESCRIPTION OF PREFERRED EMBODIMENT

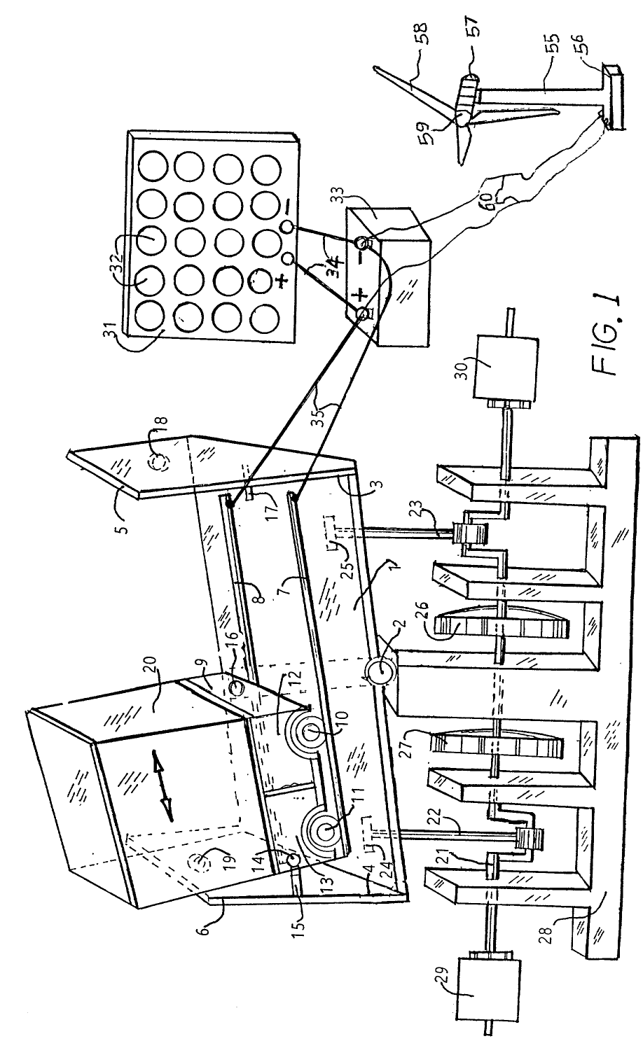

Referring now more particularly to the accompanying drawings, wherein like reference numerals designate similar parts throughout the various views, FIG. 1 illustrates an exemplary wind, solar and gravity engine in which the present invention will have particularly advantageous utility. The hybrid solar, gravity and wind engine of the present invention comprises: a lever 1, mounted on a fulcrum 2. The lever 1 is a flat straight board with ends 3 and 4. On top of lever 1 are mounted two rails 7 and 8, a vehicle 9 with wheels 10 and 11 for moving forward and backward, an electric motor 12 and a hydrogen fuel cells engine 13 are mounted on the vehicle 9, heavy masses 20 are mounted on vehicle 9. On walls 5 and 6 of lever 1 are mounted studs 15 and 17 respectively to operate the vehicle to move forward and backward. Also on said walls 5 and 6 of the lever 1 are mounted springs 18 and 19 respectively. When the masses 20 move on to spring 19 the spring 19 is compressed and stores energy. As the masses 20 retreat the spring 19 is decompressed and releases the stored energy to force the masses to move forward toward wall 5. The end 4 of lever 1 moves downward forcing the connecting rods 22 and 23 to move downward and upward reciprocally to convert lever drive into rotary movement of the crankshaft 21.

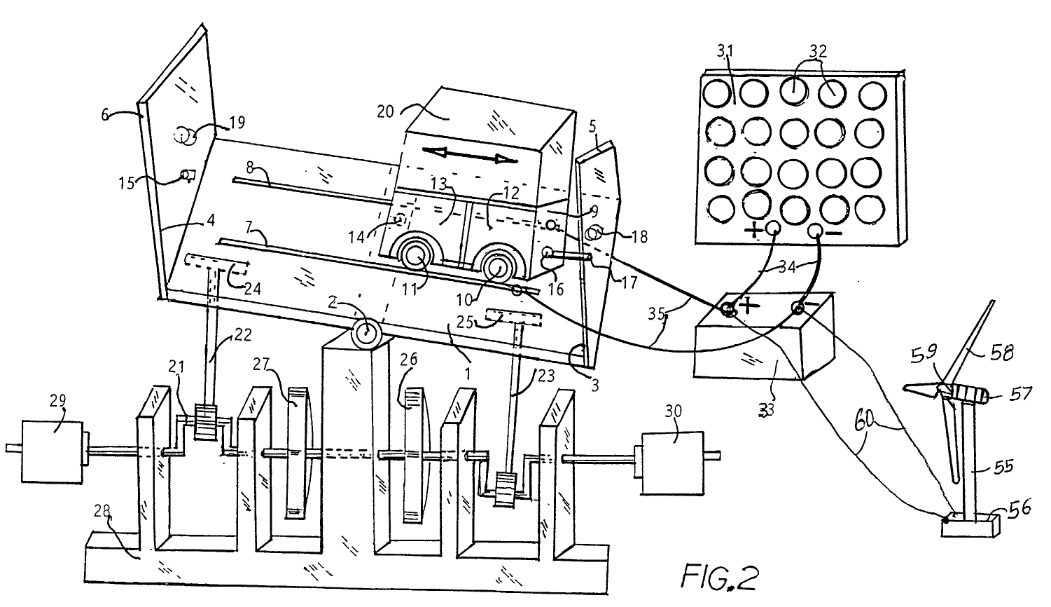

FIG. 2 is the same view as FIG. 1, when the masses 20 move on to spring 18, the spring 18 is compressed and stores energy. As the masses 20 retreat the spring 18 is decompressed and releases the stored energy to force the masses 20 to move forward toward wall 6. The end 3 of lever 1 moves downward forcing the connecting roads 22 and 23 to move downward and upward reciprocally to convert lever drive into rotary movement of the crankshaft 21.

The lever 1 works because of gravity and stored energy. Stored energy is released into energy that is stored. The electric motor 12 pulls the vehicle 9 towards fulcrum 2, the fulcrum 2 is the top of the first hill. The first hill is the highest of the ride. All of the vehicle's energy comes from being pulled up the first hill, which is the fulcrum 2.

Gravity pulls the vehicle 9 down the hill. The power for the rest of the drive comes from the pull of gravity and stored energy, not from the electric motor 12.

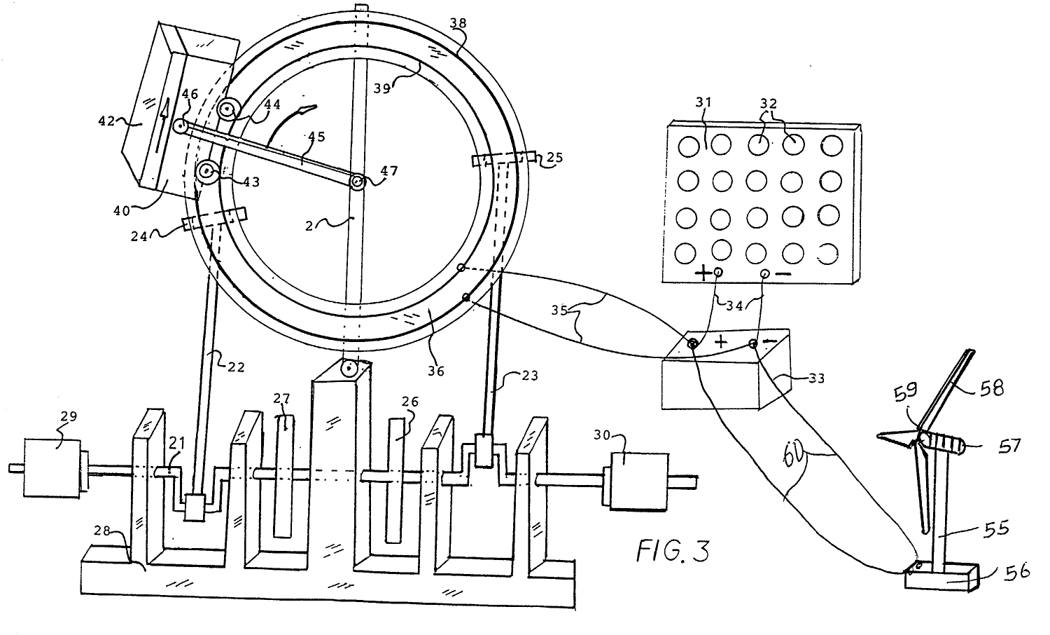

FIG. 3 is the same view as in FIGS. 1 and 2 comprising a circular lever 36 mounted on the fulcrum 2 on top of the engine's block. Two circular rails 38 and 39 are mounted on top of the circular lever 36. Connecting pins 24 and 25 mounted on the circular lever 36 and are connected to connecting rods 22 and 23 respectively. A motor vehicle 40 with wheels 43 and 44 and heavy masses 42 is running clockwise on the circular lever 36. The vehicle 40 is secured on the lever 36 by a beam 45 mounted at 46 and 47. When the vehicle 40 is above connecting pin 24 the circular lever 36 moves downward forcing the connecting rod 22 to move downward and connecting rod 23 to move upward reciprocally to convert lever drive into rotary movement of the crankshaft 21.

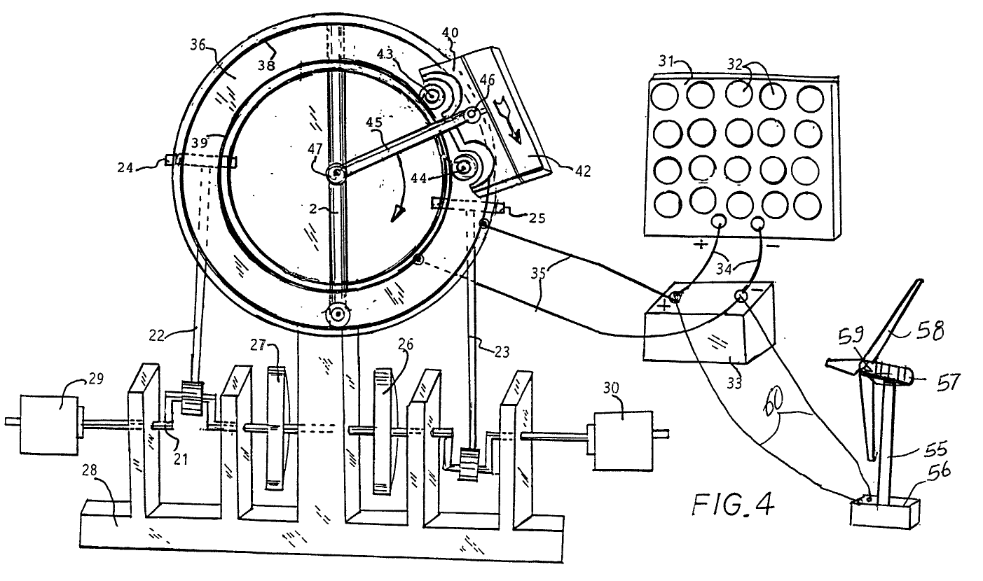

FIG. 4 is the same view as in FIG. 3. The vehicle 40 moves uphill and passes the fulcrum 2. The vehicle 40 with the heavy masses 42 stored energy, because the fulcrum 2 is the highest point, when the vehicle 40 with the heavy masses 42 passes the fulcrum 2 is running down hill releases the stored energy. The tilting lever 56 moves downward forcing the connecting rod 23 to move downward and the connecting rod 22 to move upward reciprocally to convert lever drive into rotary movement of the crankshaft 21.

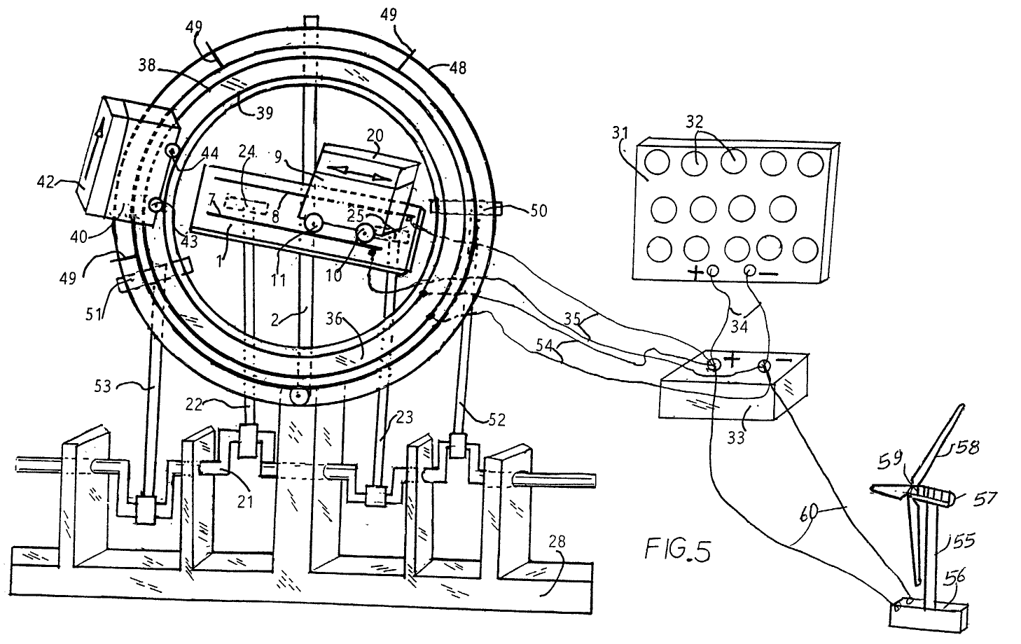

FIG. 5 comprises the same engine block as in FIGS. 2, 3, and 4 with a combination of levers a straight lever 1 and a circular lever 36 mounted On the same fulcrum 2, both levers, lever 1 and lever 36 convert lever drive into rotary movement of the crankshaft 21. The straight lever 1 has two straight rails 7 and 8 mounted on top and a vehicle 9 with wheels 10 and 11 and heavy masses 20. The circular lever 36 has two circular rails 38 and 39 and vehicle 40 with heavy masses 42 and wheels 43 and 44. The vehicle 9 with heavy masses 20 is running forward and backward. The vehicle 40 with heavy masses 42 is circulating clockwise.

The vehicles 9 and 40 move across the fulcrum 2, alternately. When vehicle 9 is over connecting pin 25, the connecting pin 25 forces the connecting rod 23 to move downward and the connecting rod 22 to move upward reciprocally to convert lever drive into rotary movement of the crankshaft 21.

The vehicle 40 with heavy masses 42 is over connecting pin 51, connecting pin 51 forces the connecting rod 53 to move downward and the connecting rod 52 to move upward reciprocally to convert lever drive into rotary movement of the crankshaft 21.

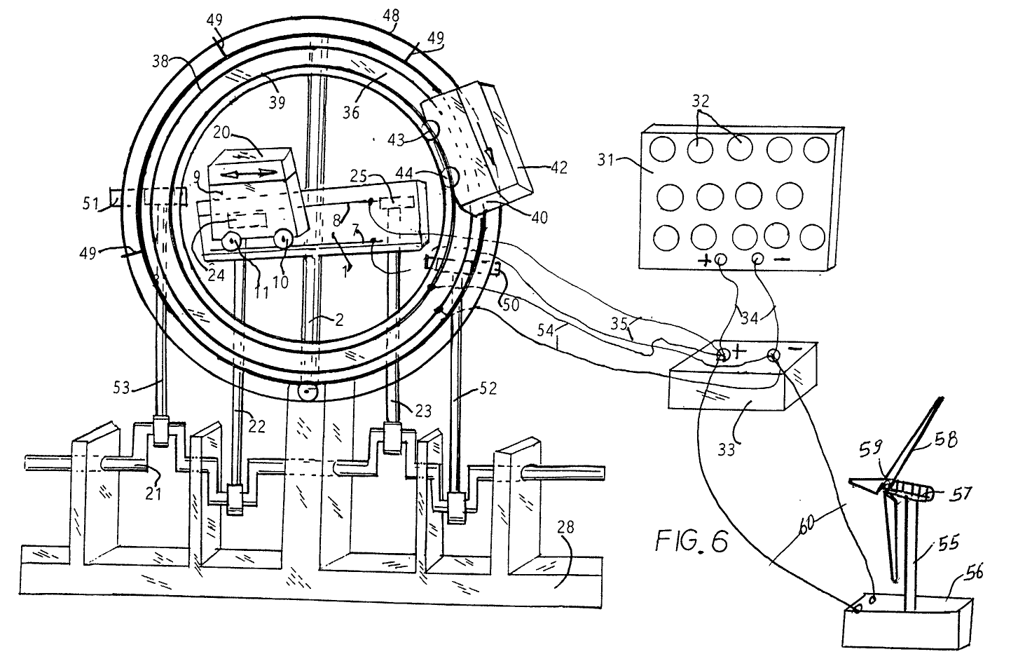

FIG. 6 is the same as FIG. 5, the vehicles 9 and 40 moving across the fulcrum 2 alternately. The vehicle 9 is over connecting pin 24. The connecting pin 24 forces the connecting rod 22 to move downward and the connecting rod 23 to move upward reciprocally to convert lever drive into rotary movement of the crankshaft 21. The vehicle 40 with heavy masses 42 is over connecting pin 50, connecting pin 50 forces the connecting rod 52 to move downward and the connecting rod 53 to move upward reciprocally, to convert lever drive into rotary movement of the crankshaft 21.

Moreover, the present invention can adopt modes of various modifications and deformations in addition to any suitable combinations of the aforementioned respective embodiments if it is within the scope of the claims.

What is claimed is:

1. A new renewable gravity, wind and solar energy engine comprising:
(i) an engine block which houses a crankshaft,
flying wheels and mechanical transmissions;
(ii) a fulcrum mounted on said engine block;
(iii) a straight lever mounted on top of said fulcrum;
(iv) a circular lever mounted on top of said fulcrum;
(v) a solar panel cell;
(vi) a horizontal-axis with turbine;
(vii) a vertical-axis wind turbine;
(viii) a hydrogen fuel cell engine;
(ix) an electric motor;
(x) a vehicle with wheels;
(xi) heavy masses loaded on said vehicle;
(xii) straight rails mounted on said straight lever;
(xiii) circular rails mounted on said circular lever;
(xiv) connecting pins mounted on the ends of said lever;
(xv) connecting rods connected to said connecting pins and also connected to said crankshaft;
(xvi) springs mounted on the ends of said straight lever to store energy by being compressed and then release energy when said springs are decompressed;
(xvii) a battery to store electricity;
(xviii) a beam mounted on said circular lever to secure said heavy masses on said circular lever; and
(xix) a circular gate mounted on said circular lever to secure said heavy masses on said circular lever.

2. A new renewable gravity, wind and solar energy engine according to claim 1, wherein said engine block houses said crankshaft, said flying wheel and said transmission.

3. A new renewable gravity, wind and solar energy engine according to claim 1, wherein said fulcrum is mounted on top of said engine block.

4. A new renewable gravity, wind and solar energy engine according to claim 1, wherein said straight lever is mounted on said fulcrum in a manner that said fulcrum is in the center of said straight lever.

5. A new renewable gravity, wind and solar energy engine according to claim 1, wherein said circular lever is mounted on said fulcrum in a manner that said fulcrum is mounted on said circular lever diametrically in the center thereof.

6. A new renewable gravity, wind and solar energy engine according to claim 1, wherein said solar panel cell is connected to said battery with electric wires to charge said battery with solar electricity generated by solar rays.

7. A new renewable gravity, wind and solar energy engine according to claim 1, wherein said horizontal-axis wind turbine is connected to said battery with electric wires to charge said battery with electricity generated by said wind turbine.

8. A new renewable, gravity, wind and solar energy engine according to claim 1, wherein said hydrogen fuel cell engine utilizing hydrogen combining with oxygen from the air to generate electricity.

9. A new renewable, gravity, wind and solar energy engine according to claim 1. wherein said electric motor is the driving engine of said vehicle with said heavy masses.

10. A new renewable, gravity, wind and solar energy engine according to claim 1. Wherein said vehicle with heavy masses has wheels to move forward and backward.

11. A new renewable gravity, wind and solar energy engine according to claim 1. Wherein said heavy masses on said vehicle create gravitational energy as they pass over said fulcrum.

12. A new renewable gravity, wind and solar energy engine according to claim 1, wherein said straight rails mounted on said straight lever are connected to said battery with electrical wires.

13. A new renewable gravity, wind and solar energy engine according to claim 1, wherein said circular rails mounted on said circular lever are connected to said battery with electrical wires.

14. A new renewable gravity, wind and solar energy engine according to claim 1, wherein said connecting pins mounted on said lever and also connected to said connecting rods.

15. A new renewable gravity, wind and solar energy engine, according to claim 1, wherein said connecting rods are connected to said connecting pins and extending downward and connected to said crankshaft to convert lever drive into rotary movement of said crankshaft.

16. A new renewable, gravity, wind and solar energy engine according to claim 1, wherein said battery is connected to said solar panel cell with electric wires to store electricity.

17. A new renewable gravity, wind and solar energy engine according to claim 1, wherein said battery is connected to said horizontal-axis, wind turbine with electric wires to store electricity.

18. A new renewable gravity, wind and solar energy engine according to claim 1, wherein said springs mounted on each end of the straight lever across the fulcrum, said springs are compressed by the heavy masses to store energy and decompressed to release energy.

19. A new renewable gravity, wind and solar energy engine according to claim 1, wherein said spring is flat spiral springs.

20. A new renewable gravity, wind and solar energy engine according to claim 1, wherein said spring is compression coil spring.

21. A new renewable gravity, wind and solar energy engine according to claim 1, wherein said spring is leaf spring.

22. A new renewable gravity, wind and solar energy engine according to claim 1, wherein said beam is mounted on said heavy masses and extending to the center of said circular lever to secure said heavy masses to hold into their rotation.

23. A new renewable gravity, wind and solar energy engine according to claim 1, wherein said circular gate mounted on said circular lever to secure said heavy masses to hold into their rotation.

24. A new renewable gravity, wind and solar energy engine according to claim 1, wherein said heavy mass is iron.

25. A new renewable gravity, wind and solar energy engine according to claim 1, wherein said heavy mass is steel.

26. A new renewable gravity, wind and solar energy engine according to claim 1, wherein said heavy masses are lead.

27. A new renewable gravity, wind and solar engine according to claim 1, wherein said heavy mass is cement.

28. A new renewable gravity, wnd and solar engine according to claim 1, wherein said heavy mass is rocks.

29. A new renewable gravity, wind and solar energy engine according to claim 1, wherein said heavy mass is water.

30. A new renewable gravity, wind and solar energy engine according to claim 1, wherein said heavy mass is sand.
